(19) United States
(12) Patent Application Publication
(10) Pub. No.: US 2006/0206270 A1
(43) Pub. Date: Sep. 14, 2006

(54) Isomarker system for component analysis of mixtures

(76) Inventors: M. Daniel Raftery, West Lafayette, IN (US); Michael A. Raftery, Berkeley, CA (US)

Correspondence Address: BRINKS HOFER GILSON & LIONE, P.O. BOX 10395, CHICAGO, IL, 60610, US

(21) Appl. No.: 11/368,983

(22) Filed: Mar. 6, 2006

Related U.S. Application Data
(60) Provisional application No. 60/658,677, filed on Mar. 4, 2005.

(51) Int. Cl. G06F 19/00

(52) U.S. Cl. 702/19; 702/22

(57) ABSTRACT

A system couples isotope markers to molecules in mixtures to identify and quantitate the molecular components in the mixtures and detects them using nuclear magnetic resonance (NMR) spectroscopy.

### RELATED APPLICATION

This application claims the benefit of U.S. Provisional Application No. 60/658,677, filed Mar. 4, 2005, the entire contents of which are incorporated herein by reference.

### GOVERNMENT INTERESTS

This invention was made with U.S. Government support under Contract No. 5R01RR01294-02 awarded by the National Institutes of Health. The U.S. Government has certain rights in this invention.

### BACKGROUND

Nuclear Magnetic Resonance (NMR) provides extremely highly detailed information on molecular structure. NMR is also quantitative because the detected signal is linearly proportional to the absolute number of active nuclei in the detected sample volume. Thus, relative numbers of hydrogen, carbon or other atoms in a molecule can be directly measured, the relative number of different molecular species in a mixture can be computed, and, by using an internal or external standard, the absolute concentration of species can be calculated.

However, when measuring the components of complex mixtures, overlapping resonances often result, which may compromise the ability to measure concentrations quantitatively. Even small molecules often give rise to twenty or more spectral lines in the ¹H NMR spectrum, leading to severe overlap for many complex mixtures. For example, in the ¹H NMR spectrum of human urine, over 1000 spectral lines can be at least partially resolved, corresponding to upwards of 100 compounds.

In an attempt to simplify this problem, a variety of multidimensional methods have been proposed to reduce the congestion of the overlapping spectral lines. These methods including a variety NMR pulse sequence experiments, such as coherent spectroscopy (COSY), TOCSY (total correlation spectroscopy), NOESY (nuclear Overhauser spectroscopy), 2D J-resolved spectroscopy, and the like. Even with these techniques, however, it is often the case that individual molecular species are difficult to identify and quantitate. In addition, low concentration species are often very difficult to detect because their signals are overwhelmed by overlapping signals from more concentrated species.

Earlier work on derivitization has been used for gas chromatographic separations, and related work by NMR has been attempted using trimethylsilyl derivatives. Recent work by Bendiak and coworkers has explored the use of acetyl labeling for the structural elucidation of oligosaccharides using multidimensional NMR. In that work, there was no detection of different species in a mixture, and the emphasis was on resolution enhancement, not on quantitating species in mixtures. In addition, sensitivity enhancement using a reduced bandwidth for the detected nuclear spin was not mentioned.

Thus, there is a need for a system that selectively quantitates species in mixtures.

### SUMMARY

The present invention provides a system to enhance the sensitivity of nuclear magnetic resonance using isotope labeled marker molecules and nuclear spin polarization transfer. The system is able to identify and quantitate molecular components in mixtures by coupling special isotope markers, or “IsoMarkers” to these molecules and detecting them using nuclear magnetic resonance (NMR) spectroscopy.

In a general aspect of the invention, a system of analyzing molecular components in a mixture includes a mechanism to couple an isotope marker (I₀) with each molecule in a selective class of molecules (A₀, A₁, A₂, . . . ) in the mixture to form molecular species (I₀-A₀, I₀-A₁, I₀-A₂, . . . ). The isotope marker (I₀) has an active nucleus that is detectable by nuclear magnetic resonance and further has a nuclear magnetic resonance frequency that is associated with the molecule (A₀, A₁, A₂, . . . ) to which the isotope marker (I₀) is coupled. The system also includes a mechanism to quantitate the molecular components by analyzing the molecular species (I₀-A₀, I₀-A₁, I₀-A₂, . . . ) by nuclear magnetic resonance.

The system may be applicable to the detection of low concentration species as well as the analysis of a wide range of mixtures, including biofluids such as blood, urine, spinal fluid, and the like, liquid foods, chemical feedstocks, such as petroleum, and so forth where different classes of molecules are present. IsoMarkers may be used to select a class of molecules, simplify their NMR spectra, increase their detection sensitivity, and allow for quantitative evaluation of that class of molecules.

Other features and advantages will be apparent from the following description, and from the claims.

### BRIEF DESCRIPTION OF THE DRAWINGS

FIG. 1 is a graph of a 500 MHz NMR spectrum of human urine.

FIG. 2a is a graph of a one dimensional ¹³C spectrum of urine.

FIG. 2b is a graph of urine derivatized with 1,1′-¹³C₂ acetic anhydride, with an inset showing the N-acetyl groups containing ¹³C-carbonyl carbons.

FIG. 3 is a graph of a derivatized mixture of 19 amino acids.

FIG. 4 is a two dimensional HSQC NMR spectrum of the derivatized mixture of 19 amino acids with the N-acetyl groups containing ¹³C-carbonyl carbons.

### DETAILED DESCRIPTION

In accordance with an embodiment of the invention, a subset of molecules (specified as A₀, A₁, A₂, etc.) that occur in the complex mixture are selected and differentiated by reacting (or interacting) them with special NMR active “isotopic spin markers.” These IsoMarkers have the following special properties:
1. They contain an NMR active nucleus whose NMR frequency is sensitive to the IsoMarker's individual reaction (or interaction) partners.
2. They also contain a highly sensitive NMR nucleus that is easily detected by NMR, and has an interaction (energy coupling with) the chemical shift sensitive NMR nucleus described in property 1.
3. The IsoMarkers are selective in their molecular partner such that each type of IsoMarker reacts with only a certain class of chemical species.

Therefore, in a reaction between IsoMarker I₀ and molecules A₀, A₁, A₂, etc., the molecular species I₀-A₀, I₀-A₁, I₀-A₂, etc. is formed, where the NMR frequency of the nuclear isotope or isotopes in IsoMarker I₀ depends on the molecular species Aₙ.

In general:
Iₘ+Aₙ→Iₘ−Aₙ, (1)
where m and n are integers indicating individual IsoMarker molecules and molecular species occurring in the complex mixture, respectively. Because of the desired selectivity between the IsoMarker and a particular class of molecules Aₙ, a chemical bond is formed between the IsoMarker and the target molecule. However, non-bonding interactions may also occur. Different IsoMarker molecules can be used to select other classes of target molecules Bₙ.

In principle, the NMR frequency may be different for all I-A partners because at least one of the NMR active nuclei in the IsoMarker molecule is chemically sensitive to its reaction partner, and changes in the electron density as felt by the NMR active isotope in the IsoMarker gives rise to distinct resonance positions. This chemical shift sensitivity allows the identification of each of the target molecular species. NMR active isotopes that have high chemical shift sensitivity, such as ¹³C, ¹⁵N, ¹⁹F, ²⁹Si, ³¹P, ⁵¹V, ¹¹⁷Sn, ¹¹⁹Sn, ¹⁹⁵Pt, and the like, are suitable for this purpose. Overlapping resonances also may occur. In this case, additional NMR or other processes, as described below, may be used to differentiate two or more reaction partners. In addition, the IsoMarkers may incorporate multiple NMR active isotopes of the same or different type of atom that have high chemical shift sensitivity, such as those listed above. This approach aids in the resolution of multiple species, their quantitation, and/or ease of detection.

A particular feature of the IsoMarker system, in accordance with the invention, is that the detected NMR spin is an additional atom or atoms that may not have much chemical shift sensitivity to the reaction partner, and thus in a mixture many of the resonances from different molecules may overlap. As a result this nuclear spin may be detected with very high sensitivity because the frequency region where it occurs is very limited. It is well known that the signal to noise (S/N) ratio in spectroscopy is, in part, determined by the frequency bandwidth of the spectrum because this bandwidth allows a certain quantity of noise to enter into the detector along with the signal. In NMR, the dominant noise voltage generated in the detector is normally termed Johnson noise, and has the characteristic amplitude V_{N} determined by the detector resistance R, the temperature T and the frequency bandwidth Δf, with k being the Boltzmann constant. Thus:
V_{N}=(4kTRΔf)^{1/2} (2)
This reduction of the bandwidth Δf decreases the noise voltage, and thus boosts the S/N of the experiment. For example, the normal spectral band width for a ¹H experiment at 500 MHz is typically 5000 Hz. If, however, all of the desired ¹H signals are within 25 Hz, the band width can be reduced by a factor of 200, leading to an increase of the S/N by 200^{1/2} or approximately a factor of 14.

In order to detect multiple species in a mixture, a two dimensional (2D) NMR experiment may be carried out in which the high sensitivity nuclear spin is detected with a very small spectral width, and the highly chemical shift sensitive nucleus that is coupled to this first nuclear spin is detected in a second, (indirect) dimension with enough resolution (time increments) so as to distinguish different species. Typical 2D experiments that are appropriate are the HSQC (hydrogen single quantum correlation) or HMQC (hydrogen multiple quantum correlation) experiments. Various methods to increase the speed of signal acquisition by this approach may be used, involving the frequency diagonalization method (FDM) in which a truncated data set is collected but still sufficient to generate high resolution 2D spectra. In cases where the directly detected nuclear spin has little or no chemical shift dispersion, it is possible to collapse the spectrum to the indirectly detected dimension(s).

Example of Chemical Isomarkers

S-ethyl trifluorothioacetate (SETFTA) can be reacted with amino acids or other amine containing molecules. The ¹⁹F NMR is a sensitive NMR nucleus, and does have a large chemical shift range but because it is somewhat distant from the reaction partner, its chemical shift sensitivity is limited. However, if SETFTA is also carbon labeled, either at the carbonyl position, or possibly at both C locations, then the ¹³C chemical shift is sensitive to the particular amino acid that is bonded to this fluorine containing IsoMarker. It is also possible to have some ¹⁹F chemical shift sensitivity that can be used to distinguish some molecular species.

A large variety of amines, including amino acids, primary amines, and other various metabolites can be converted to trifluoroacetyl derivatives as shown below:
F₃C¹³C(O)SCH₂CH₃+RNH₂→F₃C¹³C(O)NHR. (3)

In this example, the S-ethyl trifluorothioacetate is the IsoMarker, with the ¹⁹F atoms acting as the detected NMR isotope. In addition, the use of 3 F atoms in the IsoMarker increases the signal to noise. However, as the methyl fluorine nuclei are somewhat distant from the R group on the amine, the chemical shift of the detected nuclear spin will not be particularly sensitive to the R group. Therefore, the carbonyl carbon C(O) is labeled with ¹³C and thus can be used for differentiation and quantitation of the various target amine species since its chemical shift is very sensitive to the nature of the amines.

As stated above, changes in the electron density as felt by the NMR active isotope in the IsoMarker will give rise to distinct resonance positions. In this example, the carbonyl carbon chemical shift is sensitive to the R group of the target amine species via electron spin inductive effects. This chemical shift sensitivity allows the identification of each of the target molecular species. As a result, with the addition of the IsoMarker, the different amines appear in the carbon NMR spectrum as single peaks, whose concentrations are proportional to the integrated peak intensities. The fluorine atoms are used as the sensitive detector, using the fact that there are 3 of them and that their chemical shift range is very small, allowing for a reduction in bandwidth of the detector. In cases where there is coupling between the carbon atoms and protons on the target species, polarization transfer experiments can be used to reveal the isolated proton spectrum for each molecular species using a C—H double resonance experiment, or even a F—C—H triple resonance experiment.

As a further enhancement of the system, two or even three dimensional NMR experiments can be performed in order to take advantage of the frequency dispersion of additional NMR active spins on the IsoMarker such as F₃¹³C¹³C(O)NHR or even a triple resonance experiment involving ¹⁹F and the two labeled ¹³C on the trifluoracetic moiety at the same time. In some cases, a third or even fourth dimension could be used to observe ¹H spins that would help identify the particular R group or more generally the reaction partner with the IsoMarker.

Many other suitable IsoMarkers are possible. As shown below, some of these include the mixed anhydride of triflic acid and trifluoracetic acid (Reaction 4 below) potassium cyanate (5), and the mixed anhydride of formic acid and acetic acid (6) that yields formyl amine. Additional potential IsoMarkers are the acetimidate ion reaction (7), and the use of o-methyl isourea (8).
CF₃—SO₃H+CF₃—¹³COOH→CF₃—SO₂—O—¹³C(O)CF₃ CF₃—SO₂—O—¹³C(O)CF₃→RNH₂→CF₃—¹³C(O)NH—R (4)
KO¹³CN+RNH₂→NH₂—¹³C(O)—NH—R (5)
H¹³C(O)—OH+CH₃—C(O)—O—C(O)—CH₃→CH₃—C(O)—O—¹³C(O)—H CH₃—C(O)—O—¹³C(O)—H+RNH₂→H—¹³C(O)—NH—R (6)
[CH₃—¹³C(═NH₂)—OCH₃]⁺+RNH₂→[R—NH—¹³C(CH₃)═NH₂]⁺ (7)
[NH₂—¹³C(═NH₂)—OCH₃]⁺+RNH₂→[R—NH—¹³C(NH₂)═NH₂]⁺ (8)

In these cases, the carbonyl carbon is normally ¹³C labeled, but more generally the methyl carbon and/or even the N can be isotope labeled for increased chemical shift sensitivity. Also, in some cases, F can be replaced with other NMR active atoms such as ¹H. In the case of reactions 7 and 8, the central carbon in the acetimidate ion can be easily labeled with ¹³C, as can that of the o-methylisourea. Other IsoMarkers (among many) are N-hydroxysuccinamide-benzoate and benzylchloroformate that can be used to derivatize primary amines. The detected nucleus is ¹H or ¹⁹F which again is detected with a reduced bandwidth for much improved sensitivity.

In order to add IsoMarkers to molecular species that contain carboxylic acid groups, carbodiimide chemistry can be used to react the acid group with an amine. For example, the following reaction can be used:
R—C(O)—OH+R′—N═C═N—R″+R′″NH₂→R—C(O)—NH—R′″ (9)

This yields an amide which has a good chemical shift sensitivity and which can be detected sensitively when the amine (R′″NH₂) is ¹⁵N labeled. Again, this ¹⁵N is detected indirectly, with ¹H, ¹⁹F (using a F labeled amine) or other highly sensitive NMR active spins acting as the directly detected nuclear spin with reduced bandwidth.

Another approach for attaching IsoMarkers to the carboxylic acid is to use the oxonium salt:
R—C(O)—O⁻+[O(¹³CH₃)₃]+BF₄⁻→R—C(O)—O—¹³CH₃ (10)

In the example above, the methyl carbons in the oxonium salt have been isotope labeled, although other compounds such as substituting the ethyl oxonium salt are possible, which can be used as another appropriate IsoMarkers. Alternatively, the hydrogen atoms can be replaced with F as the directly detected nucleus.

In addition, metal-ligand systems can be used as IsoMarkers. Two particularly useful examples are V-containing systems, since ⁵¹V is a sensitive NMR nucleus. One such system is VOCl₃, which is known to react with hydroxylated species HO—R forming oxoligands. Alternatively, other V-ligand systems can be contemplated that are more specific to other classes of target nuclei. Another possible IsoMarker is ¹⁹⁵Pt(L₃)Cl. For example, the Pt(terpyridine) Cl system is particularly attractive since it is known to bind readily to primary amines such as amino acids. ¹⁹⁵Pt and ⁵¹V are both very frequency sensitive NMR nuclei. ¹⁹⁵Pt has a chemical shift range of over 2000 ppm. Nearby ¹H or alternatively, ¹⁹F act as the directly detected species to improve the sensitivity.

Another example of a metal containing IsoMarker is that of the methyl picolimidate ion, which reacts with amine containing target molecules as follows:
R—NH₂+[NH₂═C(OCH₃)—C₅NH₄]⁺+M⁺⁺→[R—NH—C(═NH—M⁺⁺)—C₅NH₄]⁺⁺ (11)
where the metal ion is chelated between the imine hydrogen and the ring nitrogen at the 2 position. Here the metal ion acts as the chemical shift sensitive nuclear spin while the nearby 1H is the directly detected spin.

In other implementations of the invention, it is also possible to use several related IsoMarker reagents to select different molecular classes, or to resolve remaining spectral overlap problems. For example, both the S-ethyl trifluorothioacetate and cyanate IsoMarkers can be used to identify and quantitate mixtures of various amine containing target molecules.

The IsoMarker system can be extended by combining the selection of multiple molecular subclasses using two or more IsoMarkers either independently, or in conjunction. Thus, for amino acid selection, one of the above described methods for amine marking can be combined with a method for carboxylic acid marking. This can be done either in the same reaction container, or in separate reactions. In the latter, the combination of markers is made using the multiple sets of NMR spectra that contain information on the marked molecular target species.

In addition, it is possible to separate classes of the molecules by physical separation, such as extraction into an organic solvent, fractionation using various types of chromatography or molecular sizing using ultrafiltration. This can be then combined with IsoMarkers to improve selectivity, or to increase the options for IsoMarker chemistry. For example, it is possible to extract carboxylic acid containing molecules from amino acids by protonating the acid groups and then extracting them into organic solution. An IsoMarker, such as the carbodiimide, can be reacted readily with the target molecules in the organic solution using a suitable carbodiimide derivative.

Additional IsoMarker reactions can be made available in organic solvents that are not contemplated when the reactions are restricted to aqueous solution. For example, mixtures of mono or poly hydroxylated molecules can be reacted with ¹³C labeled formic acid in the presence of DCC to form the formate ester:
ROH+H¹³COOH→R—O—¹³C(O)H (12)

Alternatively, ¹³C labeled acetic anhydride can be used to acetylate the target amines under anhydrous conditions such as that described by B. Bendiak, T. T. Fang, and D. N. M. Jones, Can. J. Chem. 80, 1032 (2002), the entire contents of which are incorporated herein by reference. However, this approach is less quantitative and more difficult because it must be carried out under anhydrous conditions, as opposed to than the procedures described above. In addition, the present approach proposes the NMR detection of the protons using reduced spectral bandwidth for improved sensitivity and quantitative determinations of molecular components of mixtures. A variety of other IsoMarker reagents can be contemplated. Target molecules such as ethanol, glycerol, glucose, and sugars are examples of the types of species that can be marked using this approach.

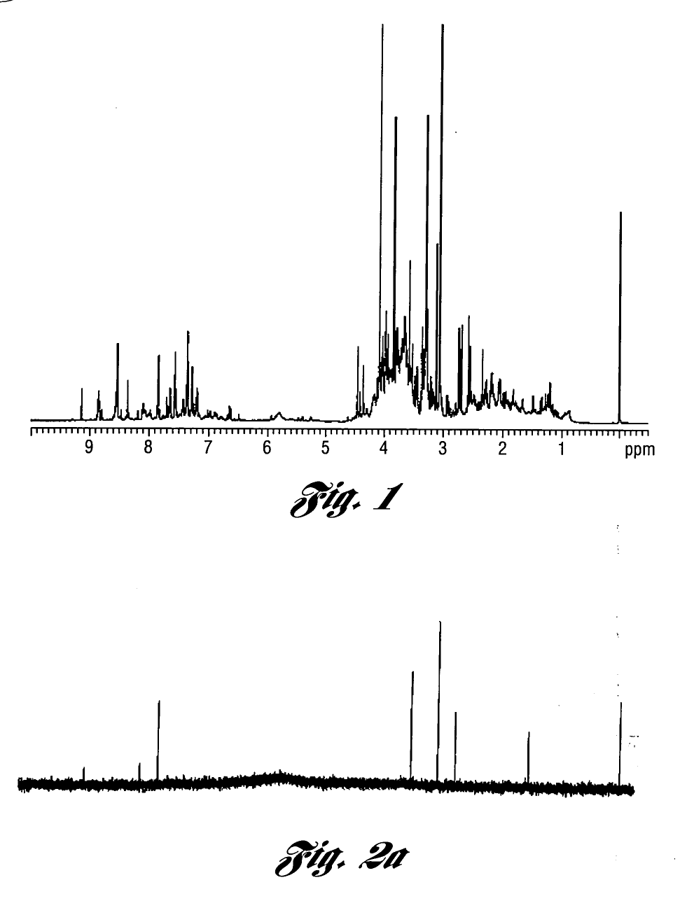

The aforementioned aspects of the invention may be implemented in various applications. For example, a number of complex mixtures may be analyzed by this system. NMR analysis of urine has been shown to reveal a large number of metabolite compounds using ¹H and ¹³C NMR methods, as well as a variety of two dimensional experiments (FIG. 1). However, spectral overlap is severe in many cases, reducing the ability of the analyst to quantitate specific molecular species. IsoMarkers are a useful approach for detecting broad classes of metabolites in such complex samples.

Urine consists of hundreds of small molecule metabolites, each of which has many ¹H resonance lines that are not well resolved. The above techniques can be used to select classes of molecular species and to quantitate them using IsoMarkers. Thus, which of the molecular species are important in the detection of early disease states, or for drug toxicology studies, for example, may be determined. Similarly, other biofluid samples, including blood, bile, spinal fluid, and the like, can be effectively analyzed using the IsoMarker approach. This approach is particularly attractive because of the large number of species that are present at low concentration. The techniques described above allow the detection of low concentration species with good spectra resolution.

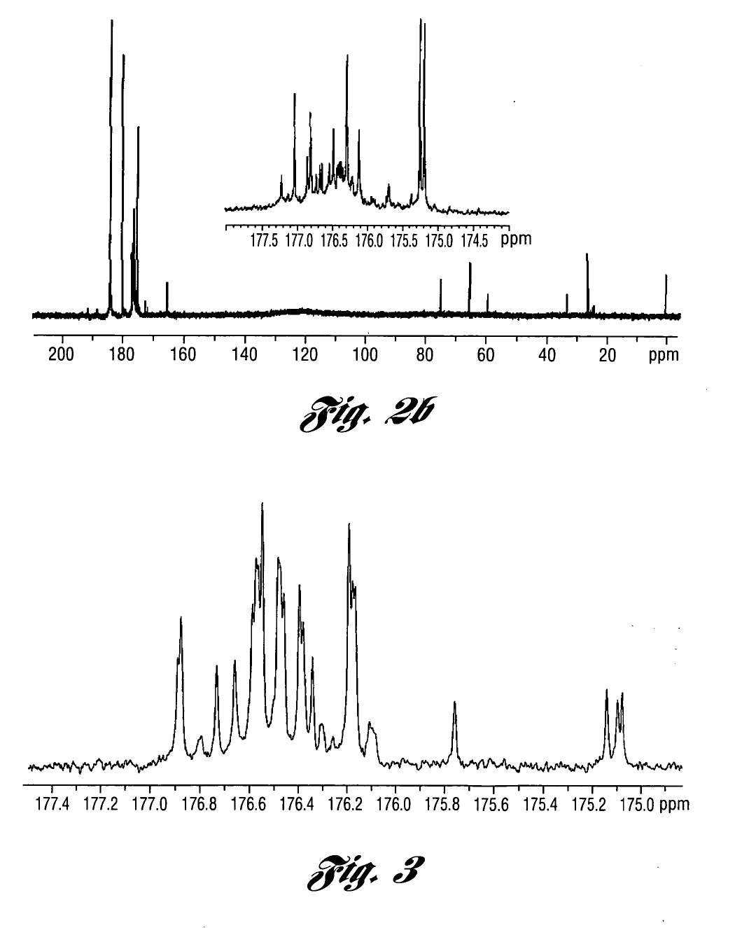

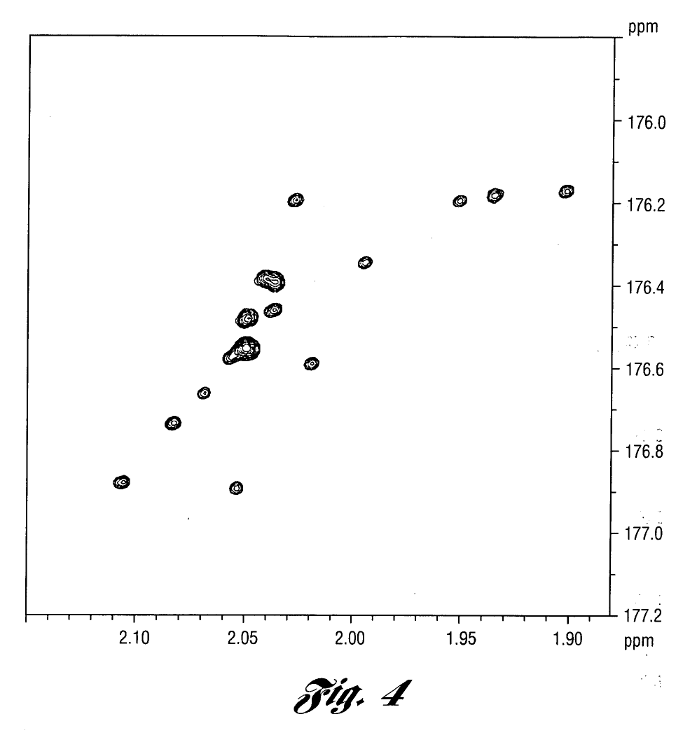

Derivitization with acetylation using ¹³C labeled carbonyl groups is a useful approach for the NMR analysis of mixtures. Specific classes of metabolites are labeled with easily observed, isotopically enriched reactant species IsoMarkers directly in aqueous solution under physiological pH. This is especially attractive for complex mixtures such as urine or other bio-fluids. For example, the derivatization of urine with labeled 1,1′-¹³C₂ acetic anhydride shows a clear advantage in sensitivity over a typical ¹³C NMR spectrum acquired without derivatization (FIG. 2). As seen in FIG. 2a, the ¹³C NMR spectrum of urine shows very weak signals for carbon of carboxylic group of amino acids while the derivatized urine spectrum shows a large number of resonances in the region of 174 to 178 ppm (FIG. 2b). These can be assigned to the N-acetyl derivatives of amino acids and further confirmed by the derivatization of individual or mixtures of amino acids (FIG. 3).

The 2D inverse-detected HSQC NMR of a mixture of 19 amino acids (FIG. 4), as well as urine samples derivatized with 1,1′-¹³C₂ acetic anhydride (FIG. 2) are well resolved. All the amino acids present in a complex urine mixture can be identified with high sensitivity based on the [¹³C-carbonyl] carbon of the N-acetyl group upon derivatization. The improved sensitivity and dispersion offers distinct advantages for identification, resonance assignment and quantification of metabolites such as phenylalanine, valine, leucine, isoleucine and other amino acids in complex urine or other biofluids from metabolic disorders by ¹³C NMR spectroscopy

Similarly, liquid foods are complex mixtures that can be analyzed for origin, composition, etc. For example, the quantitative analysis of amino acids in honey is very useful for determining the origin and purity of honey. The IsoMarker approach allows for an effective approach for identifying trace components by reaction of the IsoMarkers with selected classes of molecules. In particular, highly sensitive IsoMarkers, such as those containing CH₃ or CF₃ groups, may be used. Similar approaches can be used to probe orange juice, wine, and other liquid food samples. Dry food samples reacted with IsoMarkers and later solvated are also amenable to this approach.

Similar approaches can be used to analyze mixed chemical feedstocks, fermentation reaction mixtures, or other complex samples where the separation and quantitation of specific classes of molecular species is desired, and where spectral overlap is a problem.

It is therefore intended that the foregoing detailed description be regarded as illustrative rather than limiting, and that it be understood that it is the following claims, including all equivalents, that are intended to define the spirit and scope of this invention.

What is claimed is:

1. A system of analyzing molecular components in a mixture comprising:
a mechanism to couple an isotope marker (I₀) with each molecule in a selective class of molecules (A₀, A₁, A₂, . . . ) in the mixture to form molecular species (I₀-A₀, I₀-A₁, I₀-A₂, . . . ), the isotope marker (I₀) having an active nucleus that is detectable by nuclear magnetic resonance and further having a nuclear magnetic resonance frequency that is associated with the molecule (A₀, A₁, A₂, . . . ) to which the isotope marker (I₀) is coupled; and
a mechanism to quantitate the molecular components by analyzing the molecular species (I₀-A₀, I₀-A₁, I₀-A₂, . . . ) by nuclear magnetic resonance.

2. The system of claim 1 wherein the coupling between the isotope marker (I₀) and each molecule (A₀, A₁, A₂, . . . ) occurs through a chemical reaction.

3. The system of claim 1 wherein the coupling between the isotope marker (I₀) and each molecule (A₀, A₁, A₂, . . . ) occurs through a non-bonding interaction.

4. The system of claim 1 further comprising a mechanism to couple one or more additional isotope markers with one or more respective classes of molecules.

5. The system of claim 1 further comprising a mechanism to detect a first nuclear spin of the isotope marker with a reduced bandwidth, the nucleus having a limited chemical shift range, and wherein the first nuclear spin is coupled to another, more chemically sensitive nuclear spin.

6. The system of claim 1 wherein classes of molecules are separated physically.

7. The system of claim 6 wherein the classes of molecules are separated by extraction into an organic solvent.

8. The system of claim 6 wherein the classes of molecules are separated by fractionation using chromatography.

9. The system of claim 6 wherein the classes of molecules are separated by molecular sizing using ultrafiltration.

10. A method of analyzing molecular components in a mixture comprising:
coupling an isotope marker (I₀) with each molecule in a selective class of molecules (A₀, A₁, A₂, . . . ) in the mixture to form molecular species (I₀-A₀, I₀-A₁, I₀-A₂, . . . ), the isotope marker (I₀) having an active nucleus that is detectable by nuclear magnetic resonance and further having a nuclear magnetic resonance frequency that is associated with the molecule (A₀, A₁, A₂, . . . ) to which the isotope marker (I₀) is coupled; and
quantitating the molecular components by analyzing the molecular species (I₀-A₀, I₀-A₁, I₀-A₂, . . . ) by nuclear magnetic resonance.

11. The method of claim 10 wherein the coupling between the isotope marker (I₀) and each molecule (A₀, A₁, A₂, . . . ) occurs through a chemical reaction.

12. The method of claim 10 wherein the coupling between the isotope marker (I₀) and each molecule (A₀, A₁, A₂, . . . ) occurs through a non-bonding interaction.

13. The method of claim 10 further comprising coupling one or more additional isotope markers with one or more respective classes of molecules.

14. The method of claim 10 further comprising detecting a first nuclear spin of the isotope marker with a reduced bandwidth, the nucleus having a limited chemical shift range, and wherein the first nuclear spin is coupled to another, more chemically sensitive nuclear spin.

15. The method of claim 10 wherein classes of molecules are separated physically.

16. The method of claim 15 wherein the classes of molecules are separated by extraction into an organic solvent.

17. The method of claim 15 wherein the classes of molecules are separated by fractionation using chromatography.

18. The method of claim 15 wherein the classes of molecules are separated by molecular sizing using ultrafiltration.
